(19) United States
(12) Patent Application Publication
(10) Pub. No.: US 2011/0083130 A1
(43) Pub. Date: Apr. 7, 2011

(54) DYNAMIC EXECUTION CONTEXT MANAGEMENT IN HETEROGENEOUS COMPUTING ENVIRONMENTS

(75) Inventors: Sergey BOLDYREV, Soderkulla (FI); Antti LAPPETELAINEN, Espoo (FI)

(73) Assignee: NOKIA CORPORATION, Espoo (FI)

(21) Appl. No.: 12/571,575

(22) Filed: Oct. 1, 2009

(51) Int. Cl. G06F 15/16; G06F 9/455

(52) U.S. Cl. 718/1; 709/205

(57) ABSTRACT

Method, apparatus, and computer program product embodiments are disclosed for an adaptive computing platform that provides execution-in-place capability for a mobile computing device to enhance the processing power of the device as it moves from one external processor to another. In embodiments of the invention, a mobile wireless device stores one or more execution contexts in a memory of the mobile wireless device resulting from execution by a processor in the mobile wireless device of program code of an application stored in the memory. A transceiver or input/output device in the mobile wireless device detects that a stationary wireless device is within wireless communications range or detects a secure communication link with the stationary wireless device. The transceiver shares the execution context over a wireless communications medium to the stationary wireless device for continued execution-in-place of the application by the stationary wireless device. Later, the transceiver detects an external event that results in voluntary/involuntary closing of the secure communication link with the stationary wireless device. In response, the transceiver receives one or more execution contexts from the stationary wireless device over the wireless communications medium for continued execution-in-place of the application by the processor in the mobile wireless device. The continued execution-in-place of the application includes shared execution sessions between the mobile wireless device and the stationary wireless device.

### FIELD

The technical field relates to computing systems, and more particularly to an adaptive computing platform that provides execution-in-place capability for a computing device to enhance the processing power of the device.

### BACKGROUND

Smart Spaces are work spaces embedded with computers, information appliances, and sensors that allow people to work efficiently through access to information from computers. Smart Spaces facilitate interaction with information sources through the use of mobile wireless devices and support collaborative operations on shared data representations. The computers in the smart space may communicate wirelessly with other participants of the smart space and provide requested information through speech and visual displays. The smart space may be connected to the Internet and to remote databases to help participants to interact and collaborate.

The Micro-Nano integrated platform for transverse Ambient Intelligence applications, (MINAmI) Project, Supported by the European Commission through the Sixth Framework Programme for Research and Development, addresses Ambient Intelligence (AmI) applications, where the personal mobile device acts as a gateway. With the MINAmI Ambient Intelligence system, the physical environment can be loaded with interesting and context related information, easily and naturally accessible to the user. Information is in the tags and sensors embedded in physical surroundings and everyday objects, and it can be anything from sensor measurements from the environment or the user itself, to a piece of music or the latest news. The user can wirelessly access this information content by just touching or scanning close tags and sensors with an apparatus capable of machine reading the information content. The apparatus, such as a mobile phone may also enable wireless connection to the internet. As the interaction can be tied to a specific place, object, and time, the user is served with context related information and services. The MINAmI Project is intended to define a communication protocol/system for providing high data rate communication between a reader/writer device and large memory containing radio frequency (RF) tags operating over a very high data rate communication channel.

### SUMMARY

Method, apparatus, and computer program product example embodiments are disclosed for an adaptive computing platform that provides execution-in-place capability for a computing device to enhance the processing power of the device as it interacts with various external processors.

In example embodiments of the invention, one or more execution contexts are stored in a memory of a first device resulting from execution in the first device of program code of an application stored in the memory. The first device detects that a second device may be communicated with over a communications medium. The first device shares the execution context over a communications connection in the communications medium with the second device for continued execution-in-place of the application by the second device. When the first device detects an external event that will result in closing the communication connection with the stationary wireless device, it receives an updated execution context from the second device over the communications connection for continued execution-in-place of the application by the first device. The communications medium may be a wireless communications medium or a virtual communications medium. The sharing of the execution context and execution-in-place of the application with the second device may be managed by a virtual run-time environment. The virtual run-time environment may enable shared execution sessions between the first device and the second device. The first device may be a mobile wireless device and the second device may be a stationary wireless device.

In example embodiments of the invention, the devices may be managed by a run-time environment that enables aggregation of user and application context information and scheduling of the run-time environment. The example embodiments enable changes to be made to one or more execution contexts. Changes to execution contexts may include starting, executing, scheduling, dispersing, and aggregating of operating system processes or tasks. Code and data dispersion and aggregation may be performed by selective fetching. Selective fetching may be driven by a recovery-conscious scheduler that may be part of the run-time environment scheduler and supported by information provided by the operating system task scheduler. The execution context may be dynamically assigned and triggered by the run-time environment and allocated according to the particular or operating system task management.

In example embodiments of the invention, a second device receives one or more execution contexts over a communications medium from a first device resulting from execution in the first device of program code of an application stored in the first device. The second device executes-in-place the application. The second device determines an external event that will result in closing a secure communication link with the first device. The second device shares, before closing of the communication connection, one or more execution contexts with the first device over the communications medium for continued execution-in-place of the application by the first device. The communications medium may be a wireless communications medium or a virtual communications medium. The sharing of the execution context and execution-in-place of the application with the first device may be managed by a virtual run-time environment. The virtual run-time environment may enable shared execution sessions between the first device and the second device. The first device may be a mobile wireless device and the second device may be a stationary wireless device.

In example embodiments of the invention, the second device shares, before closing of the communication connection, an initial portion of the updated execution context with the first device over a first wireless communications connection having a first range and shares a remaining portion of the updated execution context with the first device over a second wireless communications connection having a longer range than said first range, for continued execution-in-place of the application by the first device.

The embodiments of the invention provide an adaptive computing platform that enables execution-in-place capability for a computing device to enhance the processing power of the device.

### DESCRIPTION OF THE FIGURES

FIG. 1A illustrates an example embodiment of the present invention, wherein an apparatus, such as mobile wireless device 100, shares an execution context of its execution memory contents 170 over a very high throughput wireless data link to another device, such as a stationary wireless device 200, for execution-in-place by the stationary wireless device 200.

FIG. 1B illustrates an example embodiment of the present invention, wherein an apparatus, such as the stationary wireless device 200 shares an execution context of its execution memory contents 172 over the very high throughput wireless data link to another device, such as the mobile wireless device 100, for execution-in-place by the mobile wireless device 100.

FIG. 1C illustrates an example embodiment of the virtual run-time environment 110 in the mobile wireless device 100 and the virtual run-time environment 210 in the stationary wireless device 200 sharing the execution context of an application via knowledge processors (KP) and semantic information brokers (SIB), for shared execution-in-place of the application in devices 100 and 200.

FIG. 1D illustrates an example relationship between the semantic information brokers (SIB) 120 and 220 and the Smart Space 125.

FIG. 1E illustrates an example embodiment of the virtual communications medium 190. The first virtual run-time environment 110 and the second virtual run-time environment 210 in the memory 102 of the mobile wireless device 100 run concurrently in the same memory 102. The two virtual run-time environments 110 and 210 share the execution context of an application via knowledge processors (KP) and semantic information brokers (SIB) in the virtual communications medium 190, for shared execution-in-place of the application in the two virtual run-time environments 110 and 210.

FIG. 2A illustrates an example embodiment for steps 1, 2, and 3, wherein an apparatus, such as the mobile wireless device 100 comes within range or detects a secure communication link of another device, such as the stationary wireless device 200 and the link is going up, and mobile wireless device 100 transmits an execution context of its execution memory contents 170 over the very high throughput wireless data link to stationary wireless device 200 for execution-in-place by the stationary wireless device 200, corresponding to FIG. 1A.

FIG. 2B illustrates an example embodiment for steps 4, 5, and 6, wherein an apparatus, such as the mobile wireless device 100 is within range or detects a secure communication link of another device, such as the stationary wireless device 200 and the link is up, and mobile wireless device 100 and stationary wireless device 200 exchange execution contexts of their respective execution memory contents over the very high throughput wireless data link for shared execution by both devices using a virtual run-time environment 110, 210.

FIG. 2C illustrates an example embodiment for steps 7, 8, and 9, wherein an apparatus, such as the mobile wireless device 100 moves out of range from or detects an external event that results in voluntary/involuntary closing of the secure communication link with the another device, such as the stationary wireless device 200 and the link is going down, and the stationary wireless device 200 shares an execution context of its execution memory contents 172 over the very high throughput wireless data link to mobile wireless device 100 for termination of the virtual run-time environment 110, 210 and the continued execution-in-place by the mobile wireless device 100, corresponding to FIG. 1B.

FIG. 2D illustrates an example embodiment for steps 10, 11, and 12, wherein an apparatus, such as the mobile wireless device 100 has moved out of range from or has a voluntary/involuntary closing of the secure communication link with the another device, such as the stationary wireless device 200 and the link is down.

FIG. 3 is an example flow diagram of an example embodiment, depicting steps in the procedure 300 carried out by an apparatus, such as the mobile wireless device 100.

FIG. 4 is an example flow diagram of an example embodiment, depicting steps in the procedure 400 carried out by an apparatus, such as the stationary wireless device 200.

### DISCUSSION OF EXAMPLE EMBODIMENTS OF THE INVENTION

Example memory technologies, such as Phase-change memory (PRAM), Resistive RAM (ReRAM), Magnetic RAM (MRAM), solid-electrolyte (SE) memory, Ferroelectric RAM (FeRAM), organic and polymer memory, enable a computing environment that provides efficient, seamless utilization by the mobile wireless device. These non-volatile memory technologies are collectively referred to herein as NVRAM (non-volatile main memory). Memory devices respectively based on any one of these latest memory technologies have their own respective response time and data persistence characteristics unique to the respective technology.

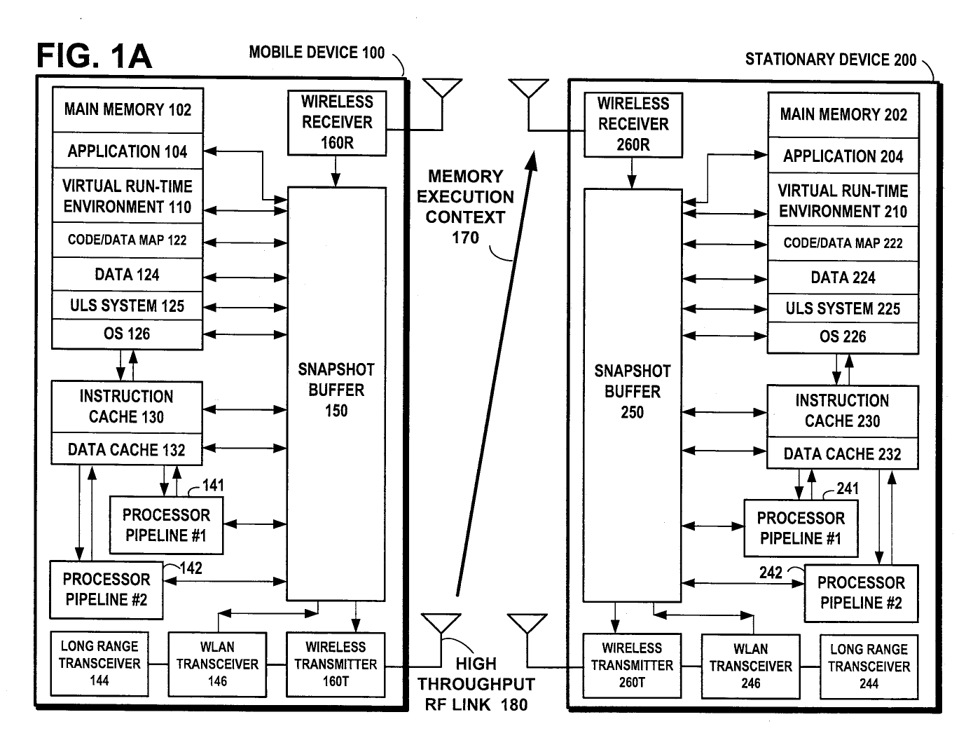

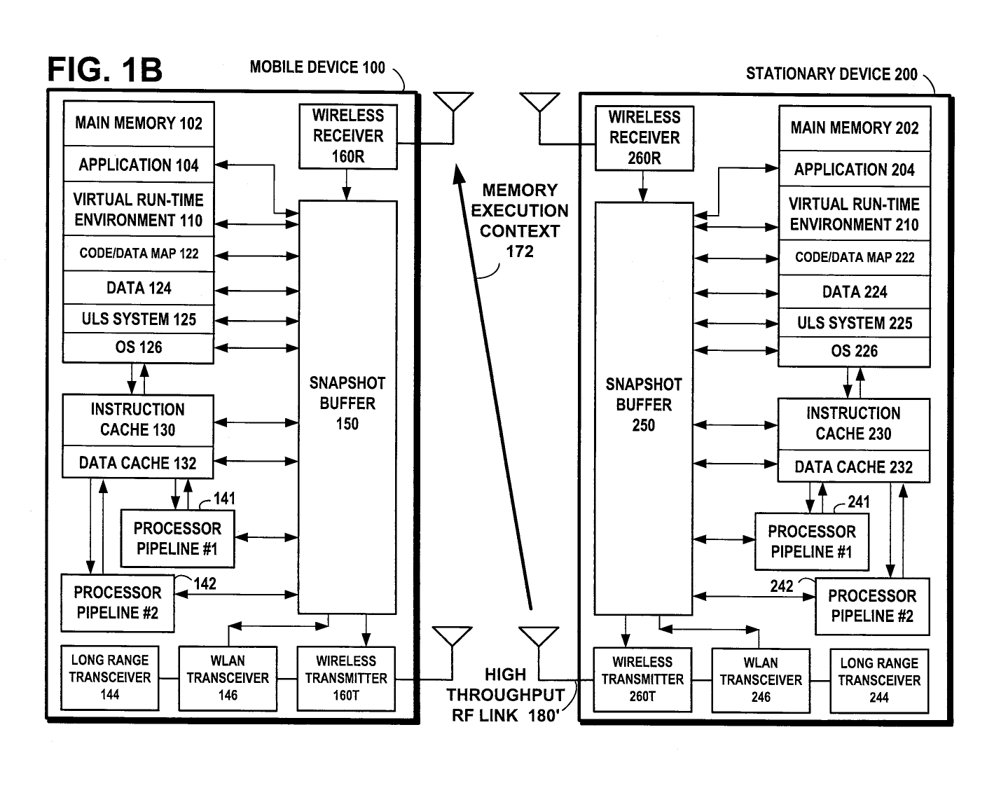

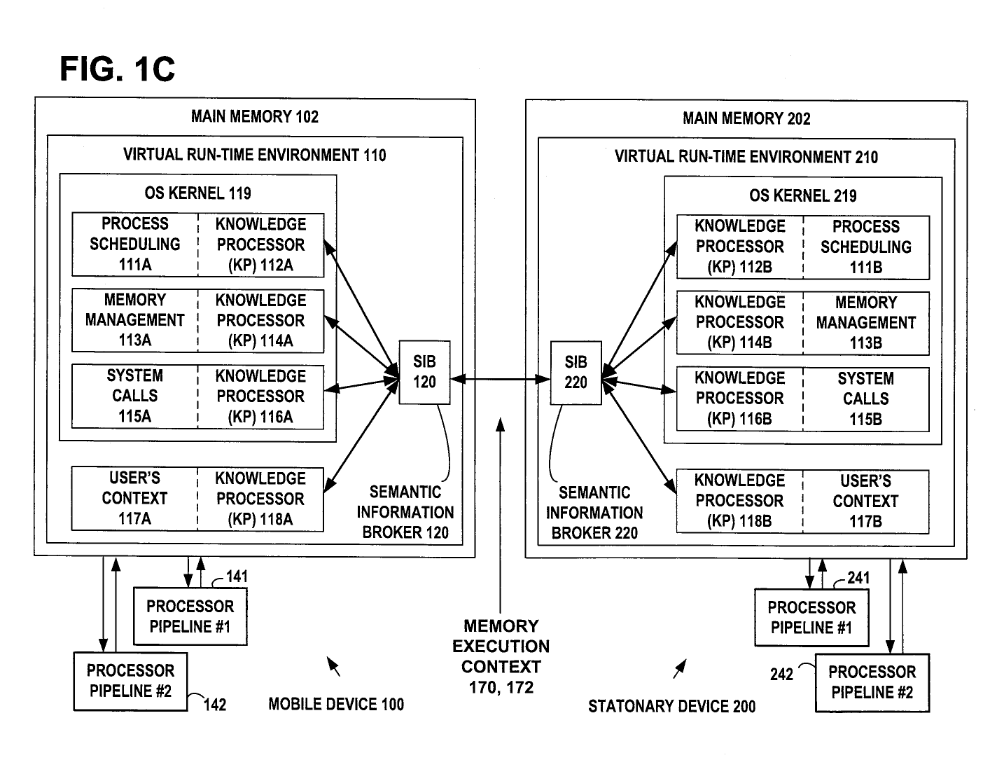

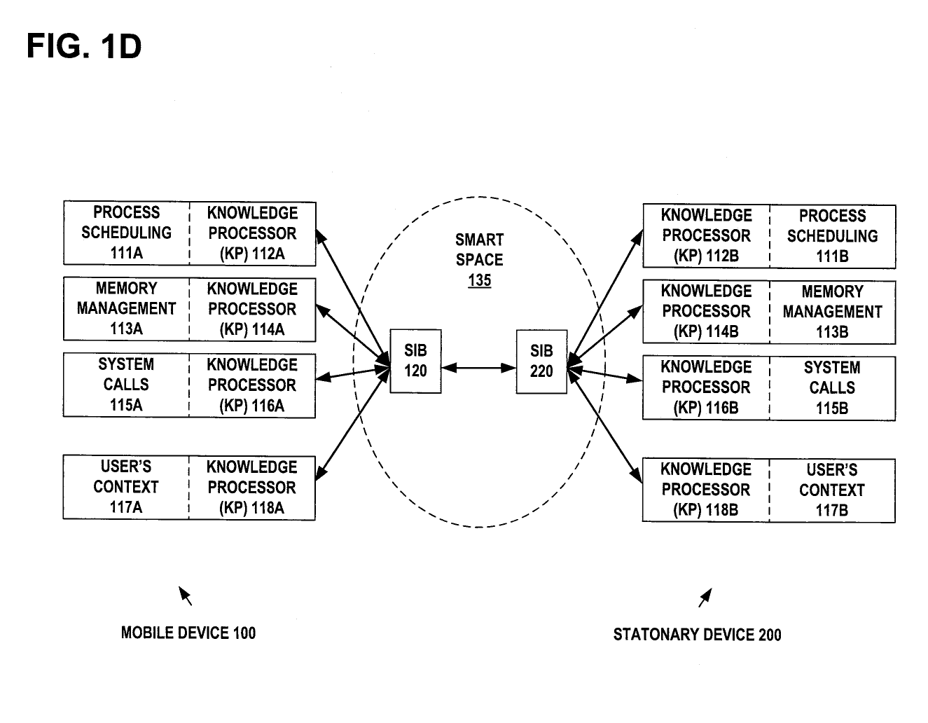

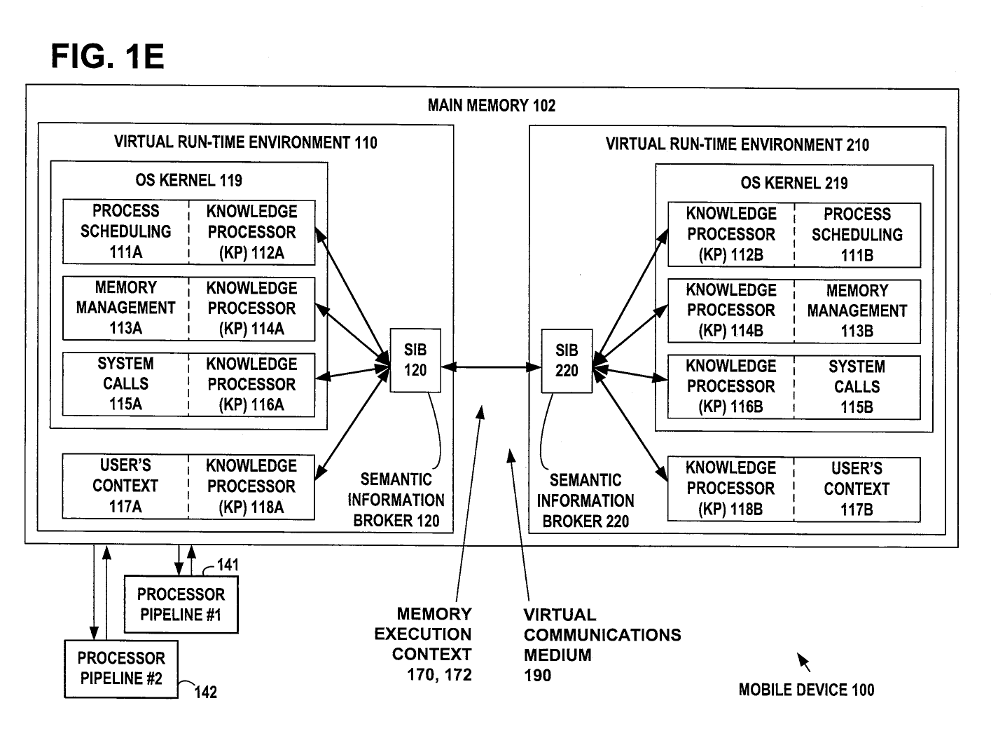

FIG. 1A illustrates an example embodiment of the present invention, wherein an apparatus, such as the mobile wireless device 100, when within range or detects a secure communication link, shares an execution context of its execution memory contents 170 over a very high throughput wireless data link 180 to another device, such as the stationary wireless device 200, for execution-in-place by the stationary wireless device 200. The embodiments include an adaptive computing platform that provides execution-in-place capability for a mobile computing device 100 to enhance the processing power of the device as it moves from one external processor 200 to another. In embodiments of the invention, the mobile wireless device 100 stores an execution context 170 in the non-volatile (NVRAM) main memory 102, instruction cache memory 130, data cache memory 132, and processors 141, 142 of the mobile wireless device 100 resulting from ongoing execution by the processors 141, 142 in the mobile wireless device of program code of an application 104 stored in the memory 102. A transceiver 160 that includes the receiver 160R and transmitter 160T in the mobile wireless device 100 detects that a stationary wireless device 200 is within wireless communications range of the mobile wireless device 100. The transceiver 160 may be any type of an input/output device capable of sending and receiving execution memory contents 170 over a very high throughput data link to the device 200. In response, a Universal Local Storage (ULS) system program 125 is invoked to transfer the execution context 170 of the mobile wireless device 100 to the snapshot buffer 150. The snapshot buffer 150 transfers the execution context 170 to the transceiver 160T, which transmits the execution context 170 over the very high throughput wireless data link 180 to the stationary wireless device 200 for continued execution-in-place of the application 104 by the stationary wireless device 200 under the control of the virtual run-time environment program 210.

The stationary wireless device 200 receives the execution context 170 in its receiver 260R from the wireless data link 180 and transfers it to the to the snapshot buffer 250 of the stationary wireless device 200. The snapshot buffer 250 invokes the Universal Local Storage (ULS) system program 225 in the stationary wireless device 200 to transfer the execution context 170 to the non-volatile (NVRAM) main memory 202, instruction cache memory 230, data cache memory 232, and processors 241, 242 of the stationary wireless device 200. The virtual run-time environment program 210 is then invoked for continued execution of the program code of the application 104 in-place by the processors 241, 242 in the stationary wireless device 200.

The mobile wireless device 100 is capable of utilizing external computational resources, such as the stationary wireless device 200, when within range or detects a secure communication link, to provide a shared execution environment. The virtual run-time environment program 110 in the mobile wireless device 100 cooperates with the virtual run-time environment program 210 in the stationary wireless device 200 to carry out a shared execution of the application 104. When the execution session is about to be stopped, either by the user's decision or because connection quality is decreasing, the execution context 172 of the execution memory contents in the stationary wireless device 200 are pulled back to the non-volatile execution memory of the mobile wireless device 100 over the very high data throughput wireless link 180′ by the Universal Local Storage (ULS) system program 125, thereby enabling the computing session to continue within the mobile wireless device 100.

The very high throughput wireless data links 180 and 180′ may be, for example, impulse radio ultra wide band (UWB) links operating at 7.9 GHz, to provide high data rate communication at 10-100 Mbit/s, or the like.

In case all of the execution memory context 172 cannot be pulled back due to disconnection of the very high data throughput wireless links 180 and 180′, other means may be used. For example, the wireless short-range transceivers 146 and 246 may use various WLAN communications protocols such as IEEE 802.11 (Wi-Fi), HiperLAN/2, IEEE 802.11a and IEEE 802.11g standards, or the like. For example, the wireless long range transceivers 144 and 244 may use various 3rd Generation wireless telephone communications protocols such as GSM EDGE, UMTS, CDMA2000, Long Term Evolution (LTE), and the like. Such short range and long range wireless protocols may be used to provide the necessary communications to complete the transfer of the execution memory context 172 to the mobile device 100.

FIG. 1B illustrates an example embodiment for an apparatus, such as the stationary wireless device 200, when within range or detects a secure communication link, shares an execution context of its execution memory contents 172 over the very high throughput wireless data link 180′ to another device, such as the mobile wireless device 100, for shared execution-in-place by both the mobile wireless device 100 and the stationary wireless device 200. The stationary wireless device 200 stores an execution context 172 in the non-volatile (NVRAM) main memory 202, cache memory 230, 232, and processors 241, 242 of the stationary wireless device 200 resulting from ongoing execution by the processors 241, 242 in the stationary wireless device of program code of the application 104 that was either transferred from the memory 102 of the mobile wireless device 100 or was already resident as application 204 in the stationary wireless device 200. Later, the receiver 160R in the mobile wireless device 100 and/or the receiver 260R in the stationary wireless device 200 detects that the mobile wireless device 100 is moving out of the wireless communications range or detects an external event that results in voluntary/involuntary closing of the secure communication link with the stationary wireless device 200 or that the connection is decreasing. In response, the Universal Local Storage (ULS) system program 225 in the stationary wireless device 200 is invoked to transfer the execution context 172 of the stationary wireless device 200 to the snapshot buffer 250. The snapshot buffer 250 transfers the execution context 172 to the transmitter 260T, which transmits the execution context 172 over the very high throughput wireless data link 180′ to the mobile wireless device 100 for continued execution-in-place of the application 104 by the mobile wireless device 100 under the control of the virtual run-time environment program 110. The transceiver 260 may be any type of an input/output device capable of sending and receiving execution memory contents 172 over a very high throughput data link to the device 100.

The Universal Local Storage (ULS) system programs 125 and 225 are described in the copending U.S. patent application Ser. No. 12/484,801, filed Jun. 15, 2009, entitled “System And Method For Distributed Persistent Computing Platform”, assigned to the instant assignee, which is incorporated herein by reference.

In another example embodiment, a user may be running an application program on his/her PC or laptop and then decides to move away to show some particular issue to a colleague working at a different location. The current execution context of the execution memory contents from the user's PC or laptop may be transferred to the mobile phone, in the manner described above for FIG. 1A. The user now continues to execute the application program in the mobile phone's processor and can travel to his colleague's location to show the results of the running application, for example by transferring the execution context of the execution memory contents from the mobile phone to the colleague's PC, without interrupting the execution session.

In the event that all of the information cannot be pulled back due to interruption of the connection of the very high data throughput wireless link, other means, such as wireless short-range connection (WLAN or like) or wireless long range connection (3G, LTE or like) may be used to provide the necessary data to complete the execution context of the non-volatile execution memory in the mobile device.

FIG. 1C illustrates an example embodiment of the virtual run-time environment 110 in the mobile wireless device 100 and the virtual run-time environment 210 in the stationary wireless device 200 sharing the execution context of an application via knowledge processors (KP) and semantic information brokers (SIB), for shared execution-in-place of the application in devices 100 and 200.

The virtual run-time environment 110 in the memory 102 of the mobile wireless device 100 includes the operating system (OS) kernel 119 that includes several knowledge processors (KP) 112A, 114A, and 116A that are program constructs in the memory 102. Each knowledge processor (KP) 112A, 114A, and 116A uses a set of definitions in a formal vocabulary to share knowledge about a category of execution context in the mobile device 100 with a respective partner knowledge processor (KP) 112B, 114B, and 116B in the stationary device 200. Each respective knowledge processor (KP) 112A, 114A, and 116A respectively manages the execution context associated with process scheduling 111A, memory management 113A, and system calls 115A in the mobile device 100. The knowledge processor performs management functions such as asking queries and making assertions. The knowledge processor (KP) 118A is a program construct in the memory 102 that manages the execution context associated with the user's context 117A in the mobile device 100 and shares knowledge about that category of execution context in the mobile device 100 with its respective partner knowledge processor (KP) 118B in the stationary device 200. Each of the knowledge processors (KP) 112A, 114A, 116A, and 118A interact with the semantic information broker 120 that is a program construct in the memory 102, which effectively performs the function of a router to direct units of memory execution context 170 from a source knowledge processor (KP) in the mobile device 100 to its respective partner knowledge processor (KP) in the stationary device 200. The semantic information broker 120 also directs units of memory execution context 172 from a source knowledge processor (KP) 112B, 114B, 116B, and 118B in the stationary device 200 to its respective partner knowledge processor (KP) 112A, 114A, 116A, and 118A in the mobile device 200.

The virtual run-time environment 210 in the memory 202 of the stationary wireless device 200 includes the operating system (OS) kernel 219 that includes several knowledge processors (KP) 112B, 114B, and 116B that are program constructs in the memory 202. Each knowledge processor (KP) 112B, 114B, and 116B uses a set of definitions in a formal vocabulary to share knowledge about a category of execution context in the mobile device 200 with a respective partner knowledge processor (KP) 112A, 114A, and 116A in the mobile device 100. Each respective knowledge processor (KP) 112B, 114B, and 116B respectively manages the execution context associated with process scheduling 111B, memory management 113B, and system calls 115B in the stationary device 200. The knowledge processor (KP) 118B is a program construct in the memory 202 that manages the execution context associated with the user's context 117B in the stationary device 200 and shares knowledge about that category of execution context in the stationary device 200 with its respective partner knowledge processor (KP) 118A in the mobile device 100. Each of the knowledge processors (KP) 112B, 114B, 116B, and 118B interact with the semantic information broker 220 that is a program construct in the memory 202, which effectively performs the function of a router to direct units of memory execution context 172 from a source knowledge processor (KP) in the stationary device 200 to its respective partner knowledge processor (KP) in the mobile device 100. The semantic information broker 220 also directs units of memory execution context 170 from a source knowledge processor (KP) 112A 114A, 116A, and 118A in the mobile device 100 to its respective partner knowledge processor (KP) 112B, 114B, 116B, and 118B in the stationary device 100.

In the example embodiments of the invention of FIG. 1C, the high throughput RF links 180 and 180′ of FIGS. 1A and 1B may provide the wireless medium for exchanging the memory execution contexts 170 and 172 between the virtual run-time environment 110 in the mobile wireless device 100 and the virtual run-time environment 210 in the stationary wireless device 200 of FIG. 1C. The semantic information broker (SIB) 120 in memory 102 may communicate through the snapshot buffer 150 and the transceiver 160T/160R to the high throughput RF links 180 and 180′ of FIGS. 1A and 1B. The semantic information broker (SIB) 220 in memory 202 may communicate through the snapshot buffer 250 and the transceiver 260T/260R to the high throughput RF links 180 and 180′ of FIGS. 1A and 1B.

FIG. 1D illustrates an example relationship between the semantic information brokers (SIB) 120 and 220 and the Smart Space 135. FIG. 1D is a simplified view of an example embodiment of knowledge processors (KP) in the mobile wireless device 100 of FIG. 1C interacting with partner knowledge processors (KP) in the stationary wireless device 200 of FIG. 1C via the semantic information brokers (SIB) 120 and 220 in the Smart Space 135.

The Smart Space 135 is constructed from one or more Semantic Information Brokers (SIB) 120 and 220, which contain schedulers, management information, listeners, and an information store. The Smart Space 135 is represented by these SIBS 120 and 220 and the total possible connectivity presented by them is given by the distributed union of all the representing SIB listeners. The SIBs 120 and 220 communicate internally to ensure that membership and credentials of the knowledge processors (KP) that have joined that Smart Space. The knowledge processors (KP) may connect via any SIB listener of any SIB in the Smart Space 135. From the point of view of any knowledge processor (KP), the information available is always the distributed union over all of the routes between all the SIBs 120 and 220. The SIBs 120 and 220 contain routing tables to other SIBs and within the Smart Space 135 and all the SIBs 120 and 220 are totally routable, but not necessarily totally connected.

The knowledge processors (KP) may include a user-interface, logic, and nodes. A knowledge processor (KP) is a composite structure that runs on a single device. A device may run many knowledge processors (KP), depending on the operating system and memory. User interfaces are not necessary or may be extremely simple in nature, such as an LCD display or a single button. The Node is the part of the knowledge processor (KP), which contains all the logic and functionality to connect to an SIB listener of an SIB in the Smart Space 135. The Node contains the logic for parsing messages and pointers to subscription handlers between the knowledge processor (KP) and the SIBs 120 and 220 of the Smart Space 135. A node may potentially connect to more than one Smart Space at a time, thus distributing and synchronizing the operations across all connected Smart Spaces. Alternatively a knowledge processors (KP) may contain more than one node.

The basic functionality for manipulating information by a knowledge processor (KP) node is:

Insert: insert information atomically;

Retract: remove information atomically;

Query: synchronously (blocking) query; returns information;

Subscribe: asynchronously (persistent, non-blocking) set up a subscription for a given query;

Unsubscribe: terminate processing of the given subscription.

Connectivity for the knowledge processors (KP) is provided through a set of SIB listeners that provide access via any given specified protocol. Typically TCP/IP is used through the standard sockets mechanism, but a Bluetooth based listener or one that uses HTTP/S may also be used. SIB listeners may provide preprocessing of the incoming messages if necessary; for example with Bluetooth profiles. One or more number of SIB listeners may be provided at any time.

A more detailed description of knowledge processors (KP), Semantic Information Brokers (SIB), and Smart Spaces is provided in the technical paper by Ian Oliver, Jukka Honkola, entitled “Personal Semantic Web Through A Space Based Computing Environment”, in Proceedings: Middleware for the Semantic Web, Second IEEE International Conference on Semantic Computing, Santa Clara, Calif., USA, Aug. 4-7, 2008, which is incorporated herein by reference.

In example embodiments of the invention, the devices may be managed by a Smart Space run-time environment that enables aggregation of user and application context information and scheduling of the Smart Space run-time environment. The example embodiments enable changes to be made to one or more execution contexts. Changes to execution contexts may include starting, executing, scheduling, dispersing, and aggregating of operating system processes or tasks. Code and data dispersion and aggregation may be performed by selective fetching. Selective fetching may be driven by a recovery-conscious scheduler that may be part of the Smart Space scheduler and supported by information provided by the operating system task scheduler. The execution context may be dynamically assigned and triggered by the Smart Space run-time environment and allocated according to the particular Smart Space or operating system task management.

Task/data dispersing and aggregation are described, for example by M. Rabin in his paper “Efficient Dispersal of Information for Security, Load Balancing, and Fault Tolerance”, Journal of the ACM, Vol. 36(2), pp. 335-348, 1989, which is incorporated herein by reference.

FIG. 1E illustrates an example embodiment of the virtual communications medium 190. The first virtual run-time environment 110 and the second virtual run-time environment 210 in the memory 102 of the mobile wireless device 100 run concurrently in separate partitions of the same memory 102 of the mobile wireless device 100. Alternately, they could both run concurrently in separate partitions of the memory 202 of the stationary device 200. The two virtual run-time environments 110 and 210 include knowledge processors (KP) and semantic information brokers (SIB), as described above for FIGS. 1C and 1D. The two virtual run-time environments 110 and 210 in memory 102 share the execution context of an application 104 via the virtual communications medium 190, for shared execution-in-place of the application in the two virtual run-time environments 110 and 210, in a manner similar to that described for FIGS. 1C and 1D. In an example embodiment, the processor pipeline 141 may run the program code for the first virtual run-time environment 110 and the processor pipeline 142 may run the program code for the second virtual run-time environment 210 in the memory 102. Alternately, one processor pipeline 141 or 142 could run both virtual run-time environments concurrently in memory 102. The memory execution contexts 170 and 172 are exchanged through the virtual communications medium 190 using interprocess communications (IPC) program constructs including, non-volatile memory buffers, semaphores, queues and tasks. In example embodiments, the first virtual run-time environment 110 in memory 102 may be considered a first device and the second virtual run-time environment 210 in memory 102 may be considered a second device, the semantic information broker 120 may be considered an input/output device for the first virtual run-time environment 110 and the semantic information broker 220 may be considered an input/output device for the second virtual run-time environment 210.

In operation, one or more execution contexts are stored in the first virtual run-time environment 110 in memory 102 resulting from execution in the first virtual run-time environment 110 of program code of an application 104 stored in the first virtual run-time environment 110 in memory 102, in FIG. 1E. The first virtual run-time environment 110 in memory 102 detects that the second virtual run-time environment 210 in memory 102 may be communicated with over the virtual communications medium 190 in memory 102. The first virtual run-time environment 110 in memory 102 shares the execution context via the semantic information broker 120 over a communications connection in the virtual communications medium 190 and via the semantic information broker 220 with the second virtual run-time environment 210 for continued execution-in-place of the application 104 by the second virtual run-time environment 210 in memory 102. When the first virtual run-time environment 110 in memory 102 detects an external event that will result in closing the communication connection with the second virtual run-time environment 210 in memory 102, the first virtual run-time environment 110 in memory 102 receives an updated execution context from the second virtual run-time environment 210 in memory 102 over the communications connection for continued execution-in-place of the application 104 by the first virtual run-time environment 110 in memory 102.

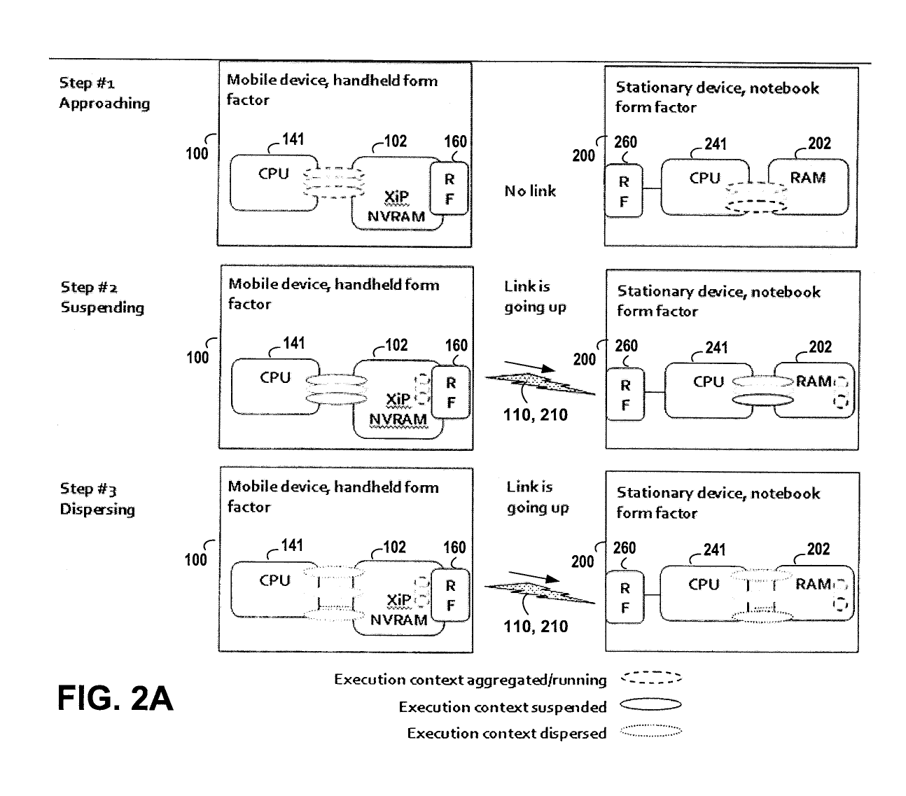

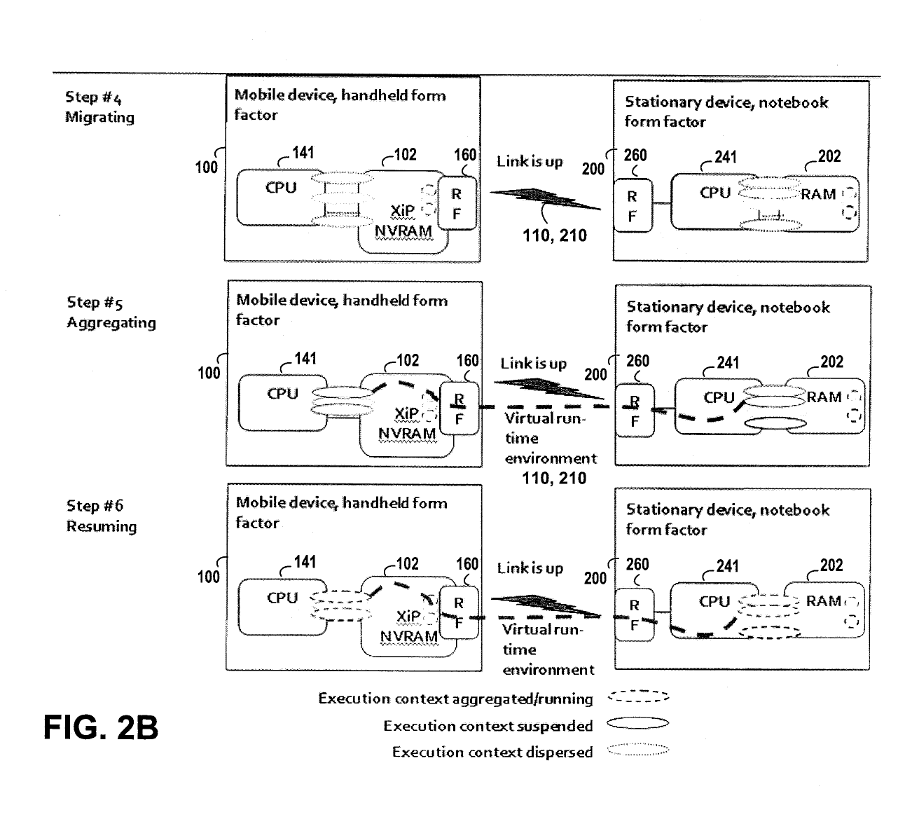

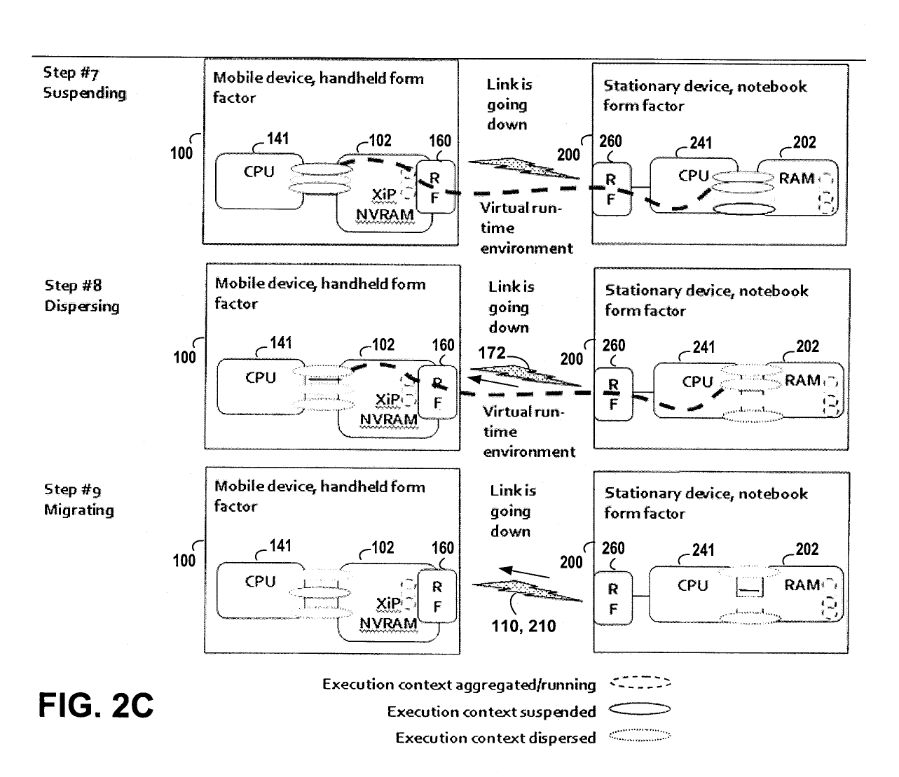

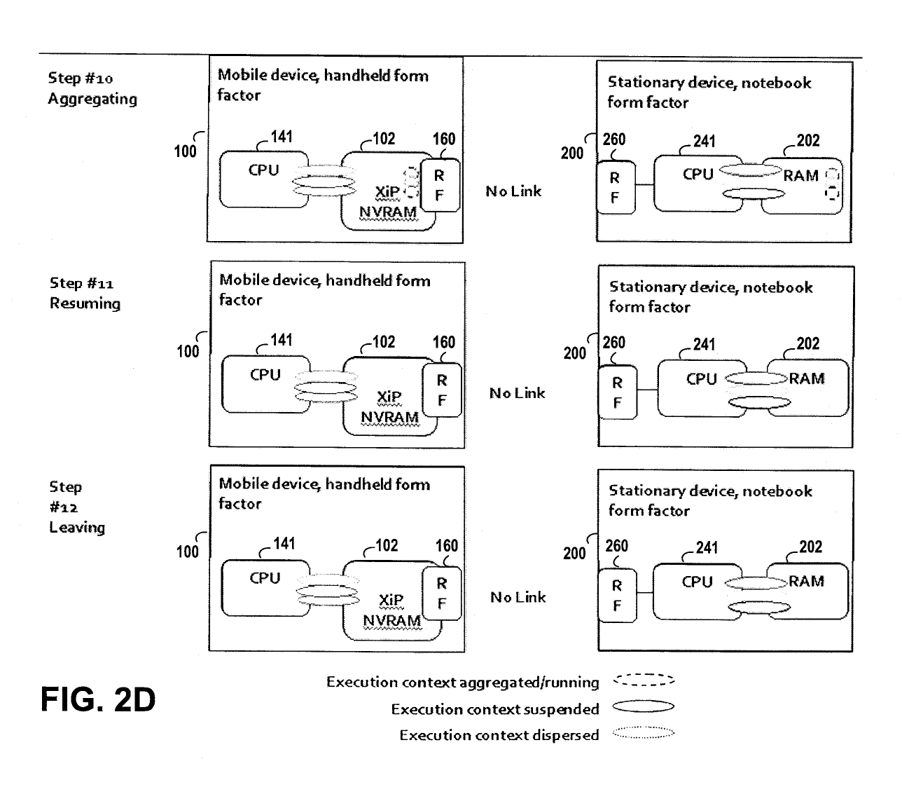

Returning to the example embodiments of FIGS. 1A through 1D, FIG. 2A illustrates an example embodiment for steps 1, 2, and 3, wherein an apparatus, such as the mobile wireless device 100 comes within range or detects a secure communication link of another device, such as the stationary wireless device 200 and the link is going up, and mobile wireless device 100 transmits an execution context of its execution memory contents 170 over the very high throughput wireless data link 180 to stationary wireless device 200 for execution-in-place by the stationary wireless device 200, corresponding to FIG. 1A. In step 1, there is no link, but the devices are approaching. In step 2, the link is going up and the mobile wireless device 100 is suspending execution. In step 3, the link is going up and the mobile wireless device 100 is dispersing the execution context of execution memory contents 170.

FIG. 2B illustrates an example embodiment for steps 4, 5, and 6, wherein an apparatus, such as the mobile wireless device 100 is within range or detects a secure communication link of another device, such as the stationary wireless device 200 and the link is up, and mobile wireless device 100 and stationary wireless device 200 exchange execution contexts of their respective execution memory contents over the very high throughput wireless data link for shared execution by both devices using a virtual run-time environment 110, 210. In step 4, the link is up and the stationary wireless device 200 is migrating the execution context of execution memory contents 170. In step 5, the link is up and the stationary wireless device 200 is aggregating the execution context of execution memory contents 170 using the virtual run-time environment 110, 210. In step 6, the link is up and the stationary wireless device 200 is resuming the execution of the application 104 using the virtual run-time environment 110, 210.

FIG. 2C illustrates an example embodiment for steps 7, 8, and 9, wherein an apparatus, such as the mobile wireless device 100 moves out of range or detects an external event that results in voluntary/involuntary closing of the secure communication link with the another device, such as the stationary wireless device 200 and the link is going down, and the stationary wireless device 200 transmits an execution context of its execution memory contents 172 over the very high throughput wireless data link 180′ to mobile wireless device 100 for termination of the virtual run-time environment 110, 210 and the continued execution-in-place by the mobile wireless device 100, corresponding to FIG. 1B. In step 7, the link is going down and the stationary wireless device 200 is suspending execution of the application 104 using the virtual run-time environment 110, 210. In step 8, the link is going down and the stationary wireless device 200 is dispersing an execution context of its execution memory contents 172 using the virtual run-time environment 110, 210. In step 9, the link is going down and the mobile wireless device 100 is migrating the execution context of the execution memory contents 172.

FIG. 2D illustrates an example embodiment for steps 10, 11, and 12, wherein an apparatus, such as the mobile wireless device 100 has moved out of range or has a voluntary/involuntary closing of the secure communication link with the another device, such as the stationary wireless device 200 and the link is down. In step 10, there is no link and the mobile wireless device 100 is aggregating the execution context of the execution memory contents 172. In step 11, there is no link and the mobile wireless device 100 is resuming the execution of the execution context of the execution memory contents 172 of application 104. In step 12, there is no link and the mobile wireless device 100 has either moved out of the range or has had a voluntary/involuntary closing of the secure communication link with the stationary wireless device 200.

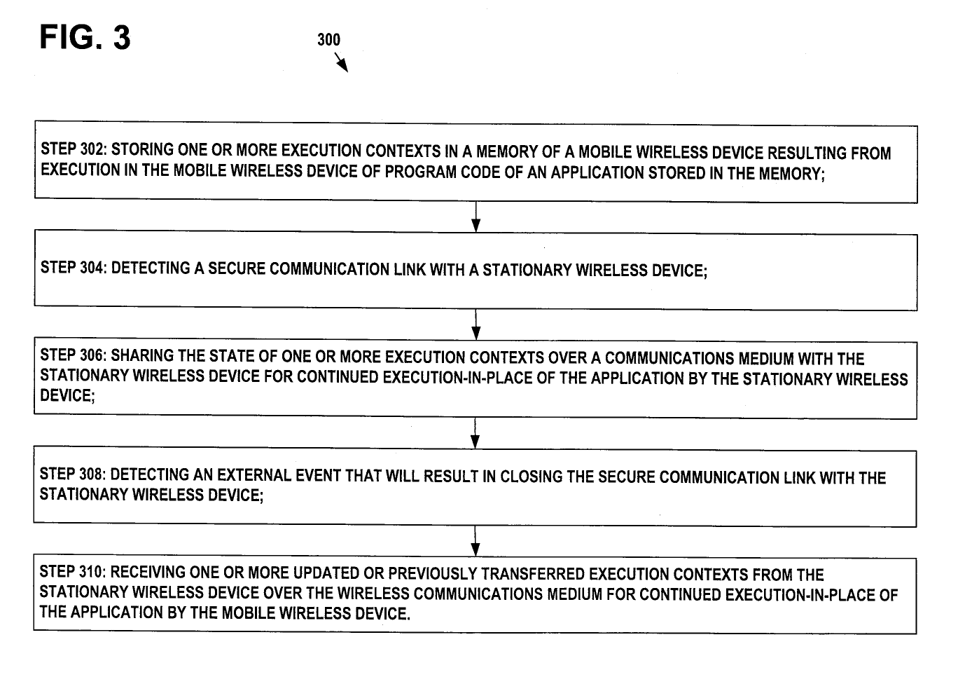

FIG. 3 is an example flow diagram of an example embodiment, depicting steps in the procedure 300 carried out by an apparatus, such as the mobile wireless device 100. The steps in the procedure of the flow diagram of FIG. 3 may be embodied as program logic stored in the memory 102 of the mobile wireless device 100 of FIG. 1A in the form of sequences of programmed instructions which, when executed in the processor 141 of the mobile wireless device 100 of FIG. 1A, carry out the functions of an exemplary disclosed embodiment. The steps in the procedure 300 are as follows:

Step 302: storing one or more execution contexts in a memory of a mobile wireless device resulting from execution in the mobile wireless device of program code of an application stored in the memory;

Step 304: detecting a secure communication link with a stationary wireless device;

Step 306: sharing the state of one or more execution contexts over a communications medium with the stationary wireless device for continued execution-in-place of the application by the stationary wireless device;

Step 308: detecting an external event that will result in closing the secure communication link with the stationary wireless device; and

Step 310: receiving one or more updated or previously transferred execution contexts from the stationary wireless device over the wireless communications medium for continued execution-in-place of the application by the mobile wireless device.

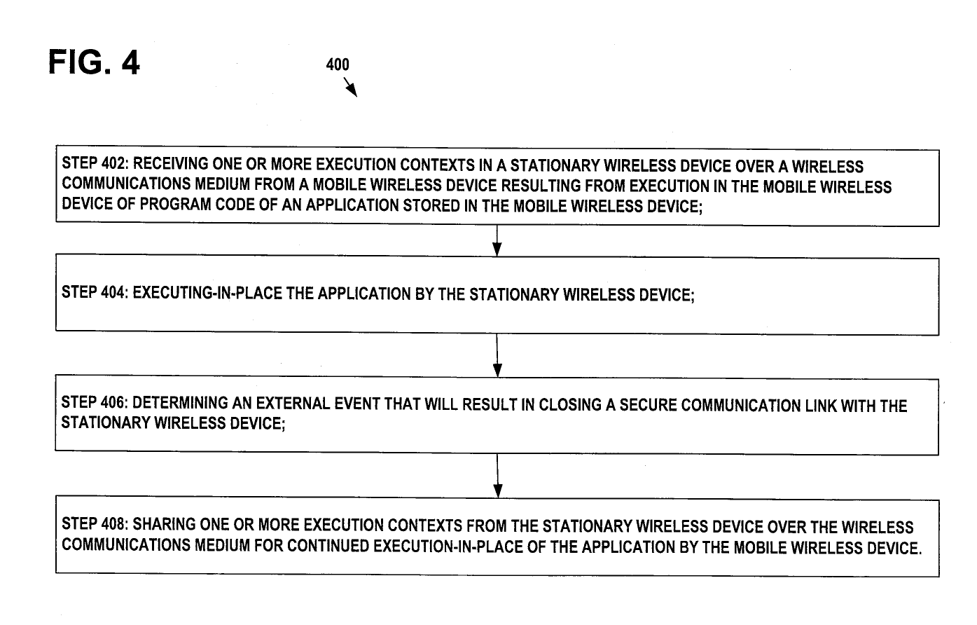

FIG. 4 is an example flow diagram of an example embodiment, depicting steps in the procedure 400 carried out by an apparatus, such as the stationary wireless device 200. The steps in the procedure of the flow diagram of FIG. 4 may be embodied as program logic stored in the memory 202 of the stationary wireless device 200 of FIG. 1A in the form of sequences of programmed instructions which, when executed in the processor 241 of the stationary wireless device 200 of FIG. 1A, carry out the functions of an exemplary disclosed embodiment. The steps in the procedure 400 are as follows:

Step 402: receiving one or more execution contexts in a stationary wireless device over a wireless communications medium from a mobile wireless device resulting from execution in the mobile wireless device of program code of an application stored in the mobile wireless device;

Step 404: executing-in-place the application by the stationary wireless device;

Step 406: determining an external event that will result in closing a secure communication link with the stationary wireless device; and

Step 408: sharing one or more execution contexts from the stationary wireless device over the wireless communications medium for continued execution-in-place of the application by the mobile wireless device.

Example embodiments of the invention include a computing environment where device participant has integrated RF based architecture of FIG. 2A and seen as distributed execution modules within a particular device (e.g. music players, smartphones, netbooks, laptops) that are physically dispersed around, running the particular run-time environment, e.g. having operating system(s) (OS) with corresponding infrastructure. Therefore, they are considered as one stackable execution element by means of corresponding combination of execution blocks of the environment (e.g. context execution pipeline, including status registers and service registers).

Example embodiments of the invention use a code/data grains schema and execution context migration procedure for distributed execution modules, for example as follows:

TABLE 1

| | |
|---|---|
| 1. | Identify the execution context groups (what OS application binary interface |
| | (ABI) particular distributed execution module runs) |
| 2. | Identify the targeted virtual run-time environment 110 ABI and instruction set |
| | architecture (ISA), allocatable resources |
| 3. | Identify the map 122 of code/data blocks allocation (provided jointly from low |
| | level by Translation lookaside buffer (TLB), from high level by Smart Space) |
| 4. | Identify execution context syncing and currently predicted branches through |
| | cache/stack snooping in cache 130, 132 and branch prediction mechanisms |
| 5. | Stall or snapshot the execution pipeline (FIG. 2A, step 2) |
| 6. | Validate any stored context |
| 7. | Disperse execution context grains according to newly defined scale/scheme, |
| | delivered by virtual run-time environment 110, 210 recovery-conscious scheduling |
| | (FIG. 2A, step 3) |
| a. | Due to newly generated grains scheme previous grains scheme could be invalidated |
| 8. | Redistribute execution context grains according to newly defined scale/scheme |
| | and generate the map 222 of newly defined groups of grains and allocatable resources |
| | (FIG. 2B, step 4) |
| 9. | Reallocate and merge (if possible) execution context grains that was written |
| | before to the selected distributed execution module (FIG. 2B, step 5) |
| a. | Before newly generated execution context scheme can be applied, the previously |
| | written execution context grains needs to be reallocated, either to temporary buffer, or |
| | to new permanent location |
| 10. | Update the map 222 of code/data blocks allocation |
| a. | Since code/data may be reallocated, the logical addressing and corresponding |
| | maps 222 needs to be updated (if applicable) |
| 11. | Code/data grains execution resumed, context restored (FIG. 2B, step 6) |
| 12. | Normal operation mode is active (depends on actual ISA, some privileged modes may be |
| | used), code/data block synchronization between the distributed execution modules |
| | can be done through cache directory management in cache 230, 232, that drives status |
| | coherence between dynamically coupled execution pipelines (e.g. “snooping”) |
| | Context migration mode can be activated at any moment then. (FIG. 2C, steps 7, 8, and 9) |
| 13. | Execution context grains scheme is kept all the time by the execution context |
| | initiator through the virtual run-time environment 110, 210 memory address space which is |
| | transparently visible by virtual run-time environment participants and, managed through the |
| | virtual memory address space |

Thus any part of execution context can be safely suspended (FIG. 2C, step 7) or resumed.(FIG. 2B, step 6)

Example embodiments of the invention may dynamically aggregate a new execution environment from running independent OSs. Having stationary device and a mobile device with running meta-application (Smart Space KPs) (FIG. 2A), once two devices are in the vicinity and the distance is within RF link threshold, scan/select/connection procedure is engaged. During that period PHY is up, protocol is up and maintenance properties are exchanged, thus devices are aware of the particular features on-the-board. Since stationary device is having more relaxed energy resources, powerful computing core and peripherals, meta-application on the mobile device can be pushed to the stationary device by user or by virtual run-time environment 110, 210. The granularity of the execution context is identified by virtual run-time environment scheduler and recovery-conscious scheduler. Thus, a volatile multicore session can be started.

The end point of the session may be voluntary or involuntary. In first case, user may explicitly pull back meta-application to the mobile device and proceed with a mobile device only. Any volatile multicore session is ended. In the second case, involuntary termination happens, meaning that special procedure may be taken in account for ensuring continuous execution session (involuntary connection close procedures).

Any participant of virtual run-time environment enabled with RF based architecture is used as one block of execution memory, managed by device local pipeline(s), memory management unit (MMU) and Translation lookaside buffer (TLB) unit, which are in charge of the code/data grains fetching, decoding, executing, scheduling, and, dispersing, aggregating. The code/data dispersion and aggregation are performed by means of selective fetching driven by recovery-conscious scheduler and can be also supported from Smart Space/OS by task scheduler. The execution context is dynamically assigned and triggered by virtual run-time environment 110, 210 and allocated according to the particular Smart Space/OS task management.

In FIG. 2B, the virtual run-time environment 110, 210 recovery-conscious scheduler may take into account the following parameters to estimate and to disperse the execution context to the distributed execution modules. The term “slave on-the-go (OTG)” refers to the stationary wireless device 200.

TABLE 2
maximum number of available execution pipelines vs. slave On-the-go
(OTG) Input/Output Operations Per Second (IOPS)
maximum number of available memory blocks vs. slave OTG IOPS
slave OTG IOPS vs. memory block IOPS
data size vs. slave OTG IOPS
energy consumption vs. ULS server IOPS vs. memory block IOPS
IO lines (RF link) vs. IOPS vs. energy consumption

Particular execution modules are fixed size, and are mapped by virtual run-time environments. According to the quality of service (QoS) policies code/data grains that needs to be executed/read/written are marked with service class, mapped with the type (async/sync/Read While Write(RWW)) and are written to or fetched from the execution modules. The size of the grains is chosen in scaled manner. Meaning that, to improve efficient mapping any block of any execution module can be appended to another execution module by means of grains adjustment. Thus, the code/data grains scheme can be implicitly determined either by software, or explicitly by hardware, or mixing both approaches (u-code), implying adjustment given by virtual run-time environment 110, 210 to the local MMU and TLB unit during the header fetch, write-back and memory access.

Virtual run-time environment 110, 210 can imply pattern and produce the necessary mapping by means of code/data importance weight and cost to handle. Thus, code/data grains scheme is kept updated. These features can be provided and guaranteed natively by virtual run-time environment 110, 210 such as Smart Space infrastructure (knowledge processor (KP)) which can be RF based infrastructure. Besides, additional hints can be taken in account. Such hints can be produced by the virtual run-time environment participants (Smart Space Knowledge Processor (KP) and Semantic Information Broker (SIB)) or in particular by information generated by application (Smart Space KP) which is consumer or producer of corresponding code/data. By mean of hints a certain schema queues can be seen. Thus, schema queue management implies the type of the code/data grain suppose to be.

TABLE 3
In case of code/data Write:

| | |
|---|---|
| 1. | Virtual run-time environment 210 slave on-the-go (OTG) 200 is setting the |
| | Write code/data grains scheme |
| 2. | Virtual run-time environment 210, receives scheme and maps it through |
| | Reader/Writer memory to the transparent OS memory address space (FIG. 2A), by means of |
| | MMU and TLB or their equivalence, then process it through the local execution pipeline(s) |
| 3. | actual processing consists of |
| a. | command sequencing, fetch stage |
| b. | vectoring to the command routine, decode stage |
| c. | determining importance weight of code/data and cost of handling by means of |
| | buffer history analysis, execute stage |
| d. | determining whether code/data needs to be written, memory access triggering stage |
| e. | according to the determined QoS policies Virtual run-time environment |
| | execution context is triggering access of the particular execution module, memory access |
| | stage combined with write back, if necessary |
| 4. | buffered code/data are written to the media |
| 5. | execution module is reporting on operation completion |

Under the step (d) code/data can be written to execution module is taking in account the
following factors:
needed code/data reliability
estimated energy efficiency
needed performance/latency
or combination of above factors,
for the certain types of execution modules.

TABLE 4
In case of code/data Read:

| | |
|---|---|
| 1. | code/data Virtual run-time environment 210 slave on-the-go (OTG) 200 is |
| | setting to Read code/data grains scheme which points a certain logical starting block address, |
| | reflected through slave OTG memory 202 (Reader/Writer memory, ULS server) to the Smart |
| | Space/OS memory address space (FIG. 2A), by means of MMU and TLB or their equivalence |
| 2. | Virtual run-time environment 210, receives scheme and process it through the |
| | local execution pipeline(s) |
| 3. | actual processing consists of |
| a. | command sequencing, fetch stage |
| b. | vectoring to the command routine, decode stage |
| c. | calculating physical execution module address by means of logical address |
| | decoding, decode stage |
| d. | checking the entry list for Smart Space/OS memory address space, memory |
| | access triggering stage |
| e. | according to the identified importance weight of code/data Virtual run-time |
| | environment is transparently accessing particular execution module, memory access stage |
| | combined with write back, if necessary |
| 4. | located code/data grains are processed and delivered to the client |
| 5. | execution module is reporting on operation completion |

TABLE 5
In case of execution context Suspend: (FIG. 2A, step 2)

| | |
|---|---|
| 1. | to identify the map of code/data blocks allocation (provided jointly |
| | from low level by TLB, from high level by distributed execution |
| | modules run-time environments, e.g. OS/Smart Space) |
| 2. | to identify execution context syncing and currently predicted branches |
| | through cache/stack snooping and branch prediction mechanisms |
| 3. | to stall or snapshot the execution pipeline |
| 4. | to validate any stored context |

TABLE 6
In case of execution context Disperse: (FIG. 2A, step 3)

| | |
|---|---|
| 1. | to validate any stored context |
| 2. | disperse execution context grains according to newly defined |
| | scale/scheme, delivered by virtual run-time environment 110, 210 |
| | recovery-conscious scheduling |
| a. | due to newly generated grains scheme previous grains scheme could |
| | be invalidated |
| 3. | redistribute execution context grains according to newly defined |
| | scale/scheme and generate the map of newly defined groups of grains |
| | and allocatable resources |

TABLE 7
In case of execution context Migrate: (FIG. 2B, step 4)

| | |
|---|---|
| 1. | reallocate execution context grains that was written before to the |
| | selected distributed execution module |
| 2. | read the map of newly defined groups of grains and allocatable |
| | resources and apply it |
| 3. | before newly generated execution context scheme can be applied, |
| | the previously written execution context grains needs to be |
| | reallocated, either to temporary buffer, or to new permanent location |

TABLE 8
In case of execution context Aggregate: (FIG. 2B, step 5)

| | |
|---|---|
| 1. | aggregate (merge, if possible) execution context grains that was |
| | written before to the selected distributed execution module |
| 2. | before newly generated execution context scheme can be applied, the |
| | previously written execution context grains needs to be reallocated, |
| | either to temporary buffer, or to new permanent location |

TABLE 9
In case of execution context Resume: (FIG. 2B, step 6)

| | |
|---|---|
| 1. | validate and update the map of newly defined groups of grains and |
| | allocatable resources for code/data blocks allocation |
| a. | since code/data may be reallocated, the logical addressing and |
| | corresponding maps needs to be updated (if applicable) |
| 2. | code/data grains execution resumed, context restored |
| 3. | normal operation mode is active (depends on actual ISA, some |
| | privileged modes needs to be used), code/data block synchronization |
| | between the distributed execution modules can be done through cache |
| | directory management, that drives status coherence between |
| | dynamically coupled execution pipelines (e.g. “snooping”) |

Separate from the lifetime activities of the execution module the housekeeping procedure is defined. It can be undertaken in real-time or in offline mode while system has enough energy and no load. The particular tasks for housekeeping are to maintain consistent code/data grain schemas and to claim unused or potentially leaked memory blocks from faulty execution modules.

The resulting example embodiments of the invention provide demanded execution in Place. The resulting example embodiments of the invention provide Balanced management in the dynamic and constrained environment of the following parameters throughout the functioning of the computing environment:
maximum number of available memory blocks vs. slave OTG TOPS
broker TOPS vs. memory block TOPS
data size vs. Virtual run-time environment TOPS
energy consumption vs. Virtual run-time environment TOPS vs. memory block IOPS
IO lines (RF link) vs. TOPS vs. energy consumption

The example embodiments of the invention result in storing one or more execution contexts in a memory of a first device/mobile wireless device resulting from execution in the first device/mobile wireless device of program code of an application stored in the memory, detecting that a second device/stationary wireless device may be communicated with over a communications medium, sharing the execution context over a communications connection in the communications medium with the second device/stationary wireless device for continued execution-in-place of the application by the second device/stationary wireless device, detecting an external event that will result in closing the communication connection with the stationary wireless device, and receiving updated execution context from the second device/stationary wireless device over the communications connection for continued execution-in-place of the application by the first device/mobile wireless device. The communications medium may be a wireless communications medium or a virtual communications medium. The sharing of the execution context and execution-in-place of the application with the second device/stationary wireless device may be managed by a virtual run-time environment. The sharing of the execution context may be managed by a virtual run-time environment that enables shared execution sessions between the mobile wireless device and the stationary wireless device. The sharing of the execution context with the second device/stationary wireless device may be managed by a virtual run-time environment that enables aggregation of user and application context information. The sharing of the execution context with the second device/stationary wireless device may be managed by a virtual run-time environment that enables scheduling of execution-in-place of the application by both the first device/mobile wireless device the second device/stationary wireless device. The sharing of the execution context with the second device/stationary wireless device may be managed by a virtual run-time environment that enables changes to be made to one or more execution contexts. The sharing of the execution context with the second device/stationary wireless device may be managed by a virtual run-time environment that enables changes to be made to one or more execution contexts, wherein the changes are drawn from the group consisting of changes to starting, executing, scheduling, dispersing, and aggregating of operating system processes or tasks. The sharing of the execution context with the second device/stationary wireless device may managed by a virtual run-time environment that performs code and data dispersion and aggregation by selective fetching driven by a recovery-conscious scheduler. The sharing of the execution context with the second device/stationary wireless device may be managed by a virtual run-time environment that dynamically assigns execution context and allocates the execution context according to operating system task management.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or sharing devices, thereby making a computer program product or article of manufacture according to the embodiments. As such, the terms “article of manufacture” and “computer program product” as used herein are intended to encompass a computer program that is stored permanently or temporarily on any computer-usable medium.

As indicated above, memory/storage devices include, but are not limited to, disks, optical disks, removable memory devices such as smart cards, SIMs, WIMs, semiconductor memories such as RAM, ROM, PROMS, etc. Sharing mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments have been disclosed, a person skilled in the art will understand that changes can be made to the specific example embodiments without departing from the spirit and scope of the invention.

What is claimed is:

1. A method, comprising:
storing one or more execution contexts in a memory of a first device resulting from execution in the first device of program code of an application stored in the memory;
detecting that a second device may be communicated with over a communications medium;
sharing the execution context over a communications connection in the communications medium with the second device for continued execution-in-place of the application by the second device;
detecting an external event that will result in closing the communication connection with the second device; and
receiving, before closing of the communication connection, updated execution context from the second device over the communications connection for continued execution-in-place of the application by the first device.

2. The method of claim 1, wherein the communications medium is a wireless communications medium or a virtual communications medium.

3. The method of claim 1, wherein the sharing of the execution context is managed by a virtual run-time environment that enables at least one of shared execution sessions between the first device and the second device, or aggregation of user and application context information.

4. The method of claim 1, wherein the sharing of the execution context with the second device is managed by a virtual run-time environment that enables scheduling of execution-in-place of the application by both the first device the second device.

5. The method of claim 1, wherein the sharing of the execution context with the second device is managed by a virtual run-time environment that enables changes to be made to one or more execution contexts, wherein said changes are drawn from the group consisting of changes to starting, executing, scheduling, dispersing, and aggregating of operating system processes or tasks.

6. The method of claim 1, wherein the sharing of the execution context with the second device is managed by a virtual run-time environment that performs code and data dispersion and aggregation by selective fetching driven by a recovery-conscious scheduler.

7. The method of claim 1, wherein the sharing of the execution context with the second device is managed by a virtual run-time environment that dynamically assigns execution context and allocates the execution context according to operating system task management.

8. An apparatus, comprising:
a processor in a first device;
a memory in the first device configured to store one or more execution contexts resulting from execution by the processor of program code of an application stored in the memory;
an input/output device configured to detect a secure communication link with a second device over a communications medium;
said input/output device configured to share one or more execution contexts over a communications connection in the communications medium with the second device for continued execution-in-place of the application by the second device;
said input/output device configured to detect an external event that will result in closing the communication connection with the second device; and
said input/output device configured to receive, before closing of the communication connection, an updated execution context from the second device over the communications connection for continued execution-in-place of the application by the first device.

9. The apparatus of claim 8, wherein the communications medium is a wireless communications medium or a virtual communications medium.

10. The apparatus of claim 8, wherein the sharing of the execution context is managed by a virtual run-time environment that enables shared execution sessions between the first device and the second wireless device.

11. The apparatus of claim 8, wherein the sharing of the execution context with the second device is managed by a virtual run-time environment that enables aggregation of user and application context information.

12. The apparatus of claim 8, wherein the sharing of the execution context with the second device is managed by a virtual run-time environment that enables scheduling of execution-in-place of the application by both the first device the second device.

13. The apparatus of claim 8, wherein the sharing of the execution context with the second device is managed by a virtual run-time environment that enables changes to be made to one or more execution contexts, wherein said changes are drawn from the group consisting of changes to starting, executing, scheduling, dispersing, and aggregating of operating system processes or tasks.

14. The apparatus of claim 8, wherein the sharing of the execution context with the second device is managed by a virtual run-time environment that performs code and data dispersion and aggregation by selective fetching driven by a recovery-conscious scheduler.

15. The apparatus of claim 8, wherein the sharing of the execution context with the second device is managed by a virtual run-time environment that dynamically assigns execution context and allocates the execution context according to operating system task management.

16. A computer readable medium, comprising:
a computer readable medium having computer program code therein;
program code in said computer readable medium, for storing one or more execution contexts in a memory of a first device resulting from execution in the first device of program code of an application stored in the memory;
program code in said computer readable medium, for detecting that a second device may be communicated with over a communications medium;
program code in said computer readable medium, for sharing the execution context over a communications connection in the communications medium with the second device for continued execution-in-place of the application by the second device;
program code in said computer readable medium, for detecting an external event that will result in closing the communication connection with the second device;
program code in said computer readable medium, for receiving, before closing of the communication connection, updated execution context from the second device over the communications connection for continued execution-in-place of the application by the first device.

17. A method, comprising:
receiving one or more execution contexts in a second device over a communications medium from a first device resulting from execution in the first device of program code of an application stored in the first device;
executing-in-place the application by the second device;
determining an external event that will result in closing a secure communication link with the second device; and
sharing, before closing of the communication connection, one or more execution contexts from the second device over the communications medium for continued execution-in-place of the application by the first device.

18. The method of claim 17, wherein the communications medium is a wireless communications medium or a virtual communications medium.

19. An apparatus, comprising:
an input/output device in a second device configured to receive one or more execution contexts over a communications medium from a first device resulting from execution in the first device of program code of an application stored in the first device;
a processor and memory in the second device configured to execute-in-place the application;
said processor configured to determine an external event that will result in closing a secure communication link with the second device; and
said input/output device configured to share, before closing of the communication connection, one or more execution contexts with the first device over the communications medium for continued execution-in-place of the application by the first device.

20. The apparatus of claim 19, wherein the communications medium is a wireless communications medium or a virtual communications medium.

21. A computer readable medium, comprising:
a computer readable medium having computer program code therein;
program code in said computer readable medium, for receiving one or more execution contexts in a second device over a communications medium from a first device resulting from execution in the first device of program code of an application stored in the first device;
program code in said computer readable medium, for executing-in-place the application by the second device;
program code in said computer readable medium, for determining an external event that will result in closing a secure communication link with the second device; and
program code in said computer readable medium, for sharing, before closing of the communication connection, one or more execution contexts from the second device over the communications medium for continued execution-in-place of the application by the first device.

22. The method of claim 1, which further comprises:
receiving, before closing of the communication connection, an initial portion of the updated execution context from the second device over a first wireless communications connection having a first range and receiving a remaining portion of the updated execution context from the second device over a second wireless communications connection having a longer range than said first range, for continued execution-in-place of the application by the first device.

23. The apparatus of claim 8, which further comprises:
a first transceiver configured to receive, before closing of the communication connection, an initial portion of the updated execution context from the second device over a first wireless communications connection having a first range;
a second transceiver configured to receive, before closing of the communication connection, a remaining portion of the updated execution context from the second device over a first wireless communications connection having a first range, for continued execution-in-place of the application by the first device.

24. The method of claim 17, which further comprises:
sharing, before closing of the communication connection, an initial portion of the updated execution context from the second device over a first wireless communications connection having a first range and sharing a remaining portion of the updated execution context from the second device over a second wireless communications connection having a longer range than said first range, for continued execution-in-place of the application by the first device.

25. The apparatus of claim 19, which further comprises:
a first transceiver configured to share, before closing of the communication connection, an initial portion of the updated execution context with the first device over a first wireless communications connection having a first range;
a second transceiver configured to share, before closing of the communication connection, a remaining portion of the updated execution context with the first device over a first wireless communications connection having a first range, for continued execution-in-place of the application by the first device.
